(19) United States
(12) Patent Application Publication
(10) Pub. No.: US 2023/0280319 A1
(43) Pub. Date: Sep. 7, 2023

(54) INTELLIGENT AUTOMATIC CONTROL SYSTEM FOR MINE GAS CHROMATOGRAPHS

(71) Applicant: CCTEG Shenyang Research Institute, Fushun (CN)

(72) Inventors: Yong Sun, Fushun (CN); Junjie Zhang, Fushun (CN); Yuntao Liang, Fushun (CN); Jie Ren, Fushun (CN); Xuewei Ge, Fushun (CN); Depeng Zhang, Fushun (CN); Honghao He, Fushun (CN); Jilin Cui, Fushun (CN); Cheng'ao Fu, Fushun (CN); Wenjie Fang, Fushun (CN); Dong Zhang, Fushun (CN); Yinhui Wang, Fushun (CN); Xuanliang Wang, Fushun (CN)

(21) Appl. No.: 18/315,320

(22) Filed: May 10, 2023

Related U.S. Application Data
(63) Continuation-in-part of application No. 17/566,574, filed on Dec. 30, 2021.

(51) Int. Cl. G01N 30/88; G01N 30/30; G01N 30/24; G01N 30/86; G08B 21/02

(52) U.S. Cl. CPC G01N 30/88; G01N 30/30; G01N 30/24; G01N 30/8665; G08B 21/02; G01N 2030/8804; G01N 2030/025

(57) ABSTRACT

The disclosure includes an intelligent automatic control system for mine gas chromatographs, comprising a CPU. The system may comprise a touch screen coupled to the CPU, a computer and a relay unit electrically coupled to the CPU, and a remote transmission module and a remote mobile control terminal communicatively coupled to the CPU. A digital output terminal may be electrically coupled through the relay unit to a component selected from the group consisting of a solenoid valve, at least one heater, a chromatograph motor, a six-way injection valve, a ten-way injection valve, a chromatograph automatic injection pump, FID ignition coils, a TCD bridge solenoid valve, at least one gas generator solenoid valve, and a standard gas/sample gas conversion valve. The system may comprise at least one temperature sensor, at least one gas pressure sensor, a TCD bridge module, and at least one pressure-controlling switch electrically coupled to the CPU.

### INTRODUCTION

### Field

The invention relates to control systems and methods of mine gas chromatography. In particular, the invention relates to an intelligent automatic control system for mine gas chromatographs and its control method.

### Description of Related Art

Gas chromatography has been an instrument of science for more than 50 years and has matured into a versatile tool. Gas chromatography is a widely applied analytic technique used for separating complex mixtures. As such, it is applied extensively in various fields, such as petrochemical analysis, pharmaceutical analysis, food analysis, environmental analysis, and polymer analysis. It is an important implement in industry, agriculture, national defense, construction, and scientific research.

Due to the continuous expansion of fields of application for gas chromatographs, the development of new products, and the universal application of electronic information technology, gas chromatography is becoming more intelligent in both design and use. This can solve the problems of poor reliability, limited functions, and an inability to upgrade technology faced by traditional gas chromatographs. This can also implement the process of man-machine dialogue to provide for better control and use of the chromatograph.

### SUMMARY

The disclosure includes an intelligent automatic control system for mine gas chromatographs, comprising a central processing unit (CPU). In some examples, the intelligent automatic control system for mine gas chromatographs comprises a touch screen coupled to the CPU. According to some examples, the intelligent automatic control system for mine gas chromatographs comprises a computer electrically coupled to the CPU. The intelligent automatic control for mine gas chromatographs system may comprises a remote transmission module communicatively coupled to the CPU. In some examples, the intelligent automatic control system for mine gas chromatographs comprises a remote mobile control terminal communicatively coupled to the remote transmission module. According to some examples, the intelligent automatic control system for mine gas chromatographs comprises a relay unit electrically coupled to the CPU and electrically coupled to a digital output terminal, the digital output terminal electrically coupled, via the relay unit, to a component selected from the group consisting of a solenoid valve, at least one heater, a chromatograph motor, a six-way injection valve, a ten-way injection valve, a chromatograph automatic injection pump, flame ionization detector (FID) ignition coils, a thermal conductivity detector (TCD) bridge solenoid valve, at least one gas generator solenoid valve, and a standard gas/sample gas conversion valve. The intelligent automatic control system for mine gas chromatographs may comprise at least one temperature sensor and at least one gas pressure sensor electrically coupled to the CPU by an analog input terminal. In some examples, the intelligent automatic control system for mine gas chromatographs comprises a TCD bridge module electrically coupled to the CPU by an analog output terminal. According to some examples, the intelligent automatic control system for mine gas chromatographs comprises at least one pressure-controlling switch electrically coupled to the CPU by a digital input terminal. The remote mobile control terminal may be a mobile phone or a tablet computer.

In some examples, the at least one heater is selected from the group consisting of a column heater, an FID heater, a TCD heater, and a reformer heater. According to some examples, the at least one temperature sensor is selected from the group consisting of a column temperature sensor, an FID temperature sensor, a TCD temperature sensor, and a reformer temperature sensor. The remote mobile control terminal may be a mobile phone or a tablet computer.

In some examples, the at least one gas generator solenoid valve is selected from the group consisting of an air generator solenoid valve, a hydrogen generator solenoid valve, and a high purity nitrogen generator solenoid valve. According to some examples, the at least one gas pressure sensor is selected from the group consisting of an air pressure sensor, a hydrogen pressure sensor, and a nitrogen pressure sensor. The remote mobile control terminal may be a mobile phone or a tablet computer.

In some examples, the at least one gas generator solenoid valve is selected from the group consisting of an air generator solenoid valve, a hydrogen generator solenoid valve, and a high purity nitrogen generator solenoid valve. According to some examples, the at least one gas pressure sensor is selected from the group consisting of an air pressure sensor, a hydrogen pressure sensor, and a nitrogen pressure sensor. The remote mobile control terminal may be a mobile phone or a tablet computer.

The disclosure also includes a control method for an intelligent automatic control system for mine gas chromatographs, wherein the intelligent automatic control system comprises a gas chromatograph, a remote mobile control terminal, at least one gas generator solenoid valve, a column, an FID, a TCD, and a reformer. In some examples, the control method for an intelligent automatic control system for mine gas chromatographs comprises operating the remote mobile control terminal. According to some examples, the control method for an intelligent automatic control system for mine gas chromatographs comprises turning on, via operating the remote mobile control terminal, a power switch of the mine gas chromatograph and the at least one gas generator solenoid valve. The control method for an intelligent automatic control system for mine gas chromatographs may comprise reading an initial column temperature, an initial FID temperature, an initial TCD temperature, and an initial reformer temperature. In some examples, the control method for an intelligent automatic control system for mine gas chromatographs comprises starting the mine gas chromatograph.

According to some examples, the control method for an intelligent automatic control system for mine gas chromatographs comprises turning on, via the remote mobile control terminal, a column heater, an FID heater, a TCD heater, and a reformer heater. The control method for an intelligent automatic control system for mine gas chromatographs may comprise heating, via the column heater, the column to a running column temperature. In some examples, the control method for an intelligent automatic control system for mine gas chromatographs comprises heating, via the FID heater, the FID to a running FID temperature. According to some examples, the control method for an intelligent automatic control system for mine gas chromatographs comprises heating, via the TCD heater, the TCD to a running TCD temperature. The control method for an intelligent automatic control system for mine gas chromatographs may comprise heating, via the reformer heater, the reformer to a running reformer temperature. In some examples, the control method for an intelligent automatic control system for mine gas chromatographs comprises achieving a normal air pressure, as read by an air pressure sensor. According to some examples, the control method for an intelligent automatic control system for mine gas chromatographs comprises achieving a normal hydrogen pressure, as read by a hydrogen pressure sensor. The control method for an intelligent automatic control system for mine gas chromatographs may comprise achieving a normal nitrogen pressure, as read by a nitrogen pressure sensor.

In some examples, the control method for an intelligent automatic control system for mine gas chromatographs comprises turning on, via the remote mobile control terminal, a TCD bridge solenoid valve. According to some examples, the control method for an intelligent automatic control system for mine gas chromatographs comprises connecting, via the remote mobile control terminal, FID ignition coils. The control method for an intelligent automatic control system for mine gas chromatographs may comprise igniting, via connecting the FID ignition coils, the FID. In some examples, the control method for an intelligent automatic control system for mine gas chromatographs comprises connecting, via the remote mobile control terminal, a six-way injection valve and a ten-way injection valve. According to some examples, the control method for an intelligent automatic control system for mine gas chromatographs comprises analyzing, via the mine gas chromatograph, a standard gas. The control method for an intelligent automatic control system for mine gas chromatographs may comprise calibrating, via the mine gas chromatograph, the standard gas.

In some examples, the control method for an intelligent automatic control system for mine gas chromatographs comprises setting, via the remote mobile control terminal, a number of cycles, an analysis time, and a sampling time of a sample gas. According to some examples, the control method for an intelligent automatic control system for mine gas chromatographs comprises starting, via the remote mobile control terminal, an injection pump. The control method for an intelligent automatic control system for mine gas chromatographs may comprise analyzing, via the mine gas chromatograph, the sample gas.

In some examples, the control method for an intelligent automatic control system for mine gas chromatographs comprises turning off, via the remote mobile control terminal, the column heater, the FID heater, the TCD heater, and the reformer heater. According to some examples, operating the remote mobile control terminal comprises operating a device selected from the group consisting of a computer and a touch screen.

The control method for an intelligent automatic control system for mine gas chromatographs may comprise sounding an alarm, prior to heating the column, the FID, the TCD, and the reformer, when an initial temperature selected from the group consisting of the initial column temperature, the initial FID temperature, the initial TCD temperature, and the initial reformer temperature is outside of a nominal initial temperature range. In some examples, the control method for an intelligent automatic control system for mine gas chromatographs comprises shutting down, one minute after sounding the alarm, the intelligent automatic control system. According to some examples, operating the remote mobile control terminal comprises operating a device selected from the group consisting of a computer and a touch screen.

The control method for an intelligent automatic control system for mine gas chromatographs may comprise sounding an alarm, prior to achieving the normal air pressure, the normal hydrogen pressure, and the normal nitrogen pressure, when a running temperature selected from the group consisting of the running column temperature, the running FID temperature, the running TCD temperature, and the running reformer temperature is outside of a nominal running temperature range. In some examples, the control method for an intelligent automatic control system for mine gas chromatographs comprises shutting down, one minute after sounding the alarm, the intelligent automatic control system. According to some examples, operating the remote mobile control terminal comprises operating a device selected from the group consisting of a computer and a touch screen.

The control method for an intelligent automatic control system for mine gas chromatographs may comprise sounding an alarm, prior to turning on the TCD bridge solenoid valve, when a pressure selected from the group consisting of the normal air pressure, the normal hydrogen pressure, and the normal nitrogen pressure is outside of a nominal pressure range. In some examples, the control method for an intelligent automatic control system for mine gas chromatographs comprises shutting down, one minute after sounding the alarm, the intelligent automatic control system. According to some examples, operating the remote mobile control terminal comprises operating a device selected from the group consisting of a computer and a touch screen.

### BRIEF DESCRIPTION OF THE DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a schematic diagram of an intelligent automatic control system for mine gas chromatographs, according to some examples.

FIG. 2 illustrates a schematic diagram of a control method for an intelligent automatic control system for mine gas chromatographs, according to some examples.

FIG. 3 illustrates a flowchart depicting a method of starting a mine gas chromatograph, according to some examples.

FIG. 4 illustrates a flowchart depicting a method of heating a mine gas chromatograph, according to some examples.

FIG. 5 illustrates a flowchart depicting a method of calibrating a mine gas chromatograph, according to some examples.

FIG. 6 illustrates a flowchart depicting a method of analyzing a sample gas and then turning off a mine gas chromatograph, according to some examples.

FIG. 7 illustrates a flowchart depicting a method of alarming and shutting down the system upon various nominal values, according to some examples.

### COMPONENT INDEX

1—Mine gas chromatograph
2—Computer Processing Unit (CPU)
3—Remote transmission module
4—Computer
5—Remote mobile control terminal
6—External gas circuit
7—Air generator solenoid valve
8—Hydrogen generator solenoid valve
9—High-purity nitrogen generator solenoid valve
101—Column heater
102—Flame ionization detector (FID) heater
103—Thermal conductivity detector (TCD) heater
104—Reformer heater
105—Chromatograph motor
106—Six-way injection valve
107—Ten-way injection valve
108—Chromatograph automatic injection pump
109—Chromatograph standard gas/sample gas switch valve
110—FID ignition coils
111—Touch screen
112—Column temperature sensor
113—FID temperature sensor
114—TCD temperature sensor
115—Reformer temperature sensor
116—Air pressure sensor
117—Hydrogen pressure sensor
118—Nitrogen pressure sensor
119—Pressure-controlling switch group
120—TCD bridge module
121—Relay unit
122—TCD bridge solenoid valve
201—Digital output terminal
202—Analog input terminal
203—Analog output terminal
204—Digital input terminal
311—Internet

### DETAILED DESCRIPTION

Although specific examples are disclosed below, inventive subject matter extends beyond the specifically disclosed examples to other alternative examples and/or uses and to modifications and equivalents thereof. Thus, the scope of the claims appended hereto is not limited by any of the particular examples described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain examples; however, the order of description should not be construed to imply that these operations are order-dependent. Additionally, the structures, systems, and/or devices described herein may be embodied as integrated components or as separate components.

For purposes of comparing various examples, certain aspects and advantages of these examples are described. Not necessarily all such aspects or advantages are achieved by any particular example. Thus, for example, various examples may be carried out in a manner that achieves or optimizes one advantage or group of advantages as taught herein without necessarily achieving other aspects or advantages as may also be taught or suggested herein.

Gas chromatography in the prior art needs two hours to stabilize after starting up, as well as two hours to cool down after shutting down. These periods add up to four hours during which analysts cannot test and analyze gases. Based on a standard eight-hour workday, there are now only four hours left each day during which the analysts may actually perform their job—this is a hindrance to work efficiency and productivity. However, a large number of gas bladders may compel their laboratory analysts to work overtime in order to overcome this discrepancy, resulting in increased inconvenience to these laboratory analysts and the management personnel who oversee them.

The invention disclosed herein aims to solve the deficiencies in the prior art while still meeting the requirements for intelligent automatic control for mine gas chromatographs. Illustrated herein is a system for mine gas chromatographs that can be controlled remotely and intelligently on a remote mobile control terminal. Possible examples include realizing this remote control through the use of the internet.

According to some examples, the remote intelligent automatic control for mine gas chromatographs can start up the mine gas chromatographs through the use of a mobile phone or a tablet computer. In some examples, this start-up occurs in advance of the actual need for the mine gas chromatograph, thus saving the time spent by laboratory analysts and management personnel waiting for the mine gas chromatograph to stabilize after start-up or cool down after shutting down for the day. This may improve their work efficiency and reduce their overall workloads.

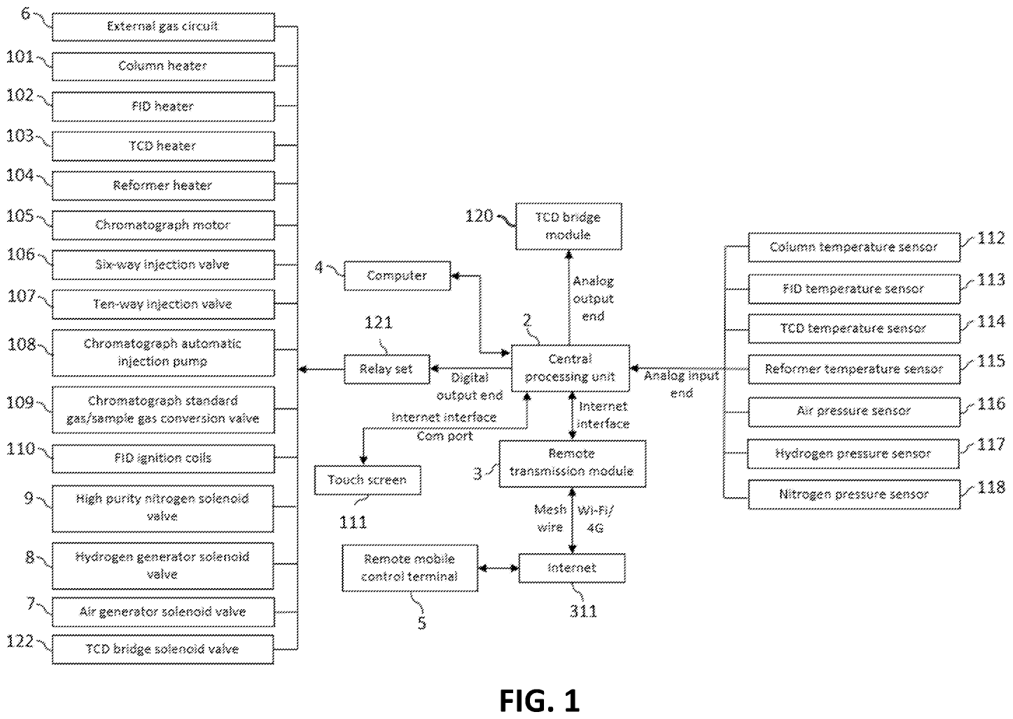

FIG. 1 illustrates a technical solution to the flaws of the prior art, according to some examples. An intelligent automatic control system for mine gas chromatographs may comprise a computer processing unit (CPU) 2 coupled to a computer 4 and a touch screen 111. In some examples, the CPU 2 is electrically coupled to a digital output terminal 201, an analog input terminal 202, an analog output terminal 203, and a digital input terminal 204.

The digital output terminal 201 may be electrically coupled, through a relay unit 121, to a solenoid valve, such as the air generator solenoid valve 7, hydrogen generator solenoid valve 8, and the high-purity nitrogen generator solenoid valve 9. In some examples, the digital output terminal 201 is electrically coupled to all three of these solenoid valves. According to some examples, the digital output terminal 201 is additionally electrically coupled to a heater, such as a column heater 101, a flame ionization detector (FID) heater 102, a thermal conductivity detector (TCD) heater 103, and a reformer heater 104. In some examples, the digital output terminal 201 is electrically coupled to all four of these heaters.

The digital output terminal 201 may be electrically coupled to a chromatograph motor 105, a six-way injection valve 106, a ten-way injection valve 107, and a chromatograph automatic injection pump 108. According to some examples, the digital output terminal 201 is additionally electrically coupled to an FID ignition coil 110 or a plurality of FID ignition coils 110. In some examples, the digital output terminal 201 is electrically coupled to a TCD bridge solenoid valve 122 to facilitate coupling the previously described three types of gas generator solenoid valves on the automatic control device of the external gas circuit 6. While examples, as illustrated in FIG. 1, show all of these components coupled to the digital output terminal 201, the invention as described herein is not limited to these examples, and components, as shown, may be removed without destroying the underlying concept of the present invention.

In some examples, the analog input terminal 202 is electrically coupled to a temperature sensor, such as a column temperature sensor 112, an FID temperature sensor 113, a TCD temperature sensor 114, and a reformer temperature sensor 115. According to some examples, the analog input terminal 202 is coupled to all four described temperature sensors.

The analog output terminal 203 may be electrically coupled to a TCD bridge module 120. In some examples, the digital input terminal 204 is electrically coupled to a pressure-controlling switch group 119.

Additionally, the relay unit 121 may be electrically coupled to a chromatograph standard gas/sample gas switch valve 109. In some examples, the analog input terminal 202 is electrically coupled to a gas pressure sensor, such as an air pressure sensor 116, a hydrogen pressure sensor 117, and a nitrogen pressure sensor 118. According to some examples, the analog input terminal 202 is coupled to all three of these described gas pressure sensors.

In some examples, the CPU 2 is coupled to the remote transmission module 3, the internet 311, and the remote mobile control terminal 5. The order of coupling for this sequence may be the order in which the components are written, i.e., the CPU 2 may communicatively couple to the remote transmission module 3, and the remote transmission module 3 may make use of the internet 311 to communicatively coupled to the remote mobile control terminal 5. According to some examples, the remote mobile control terminal 5 is a mobile phone or a tablet computer.

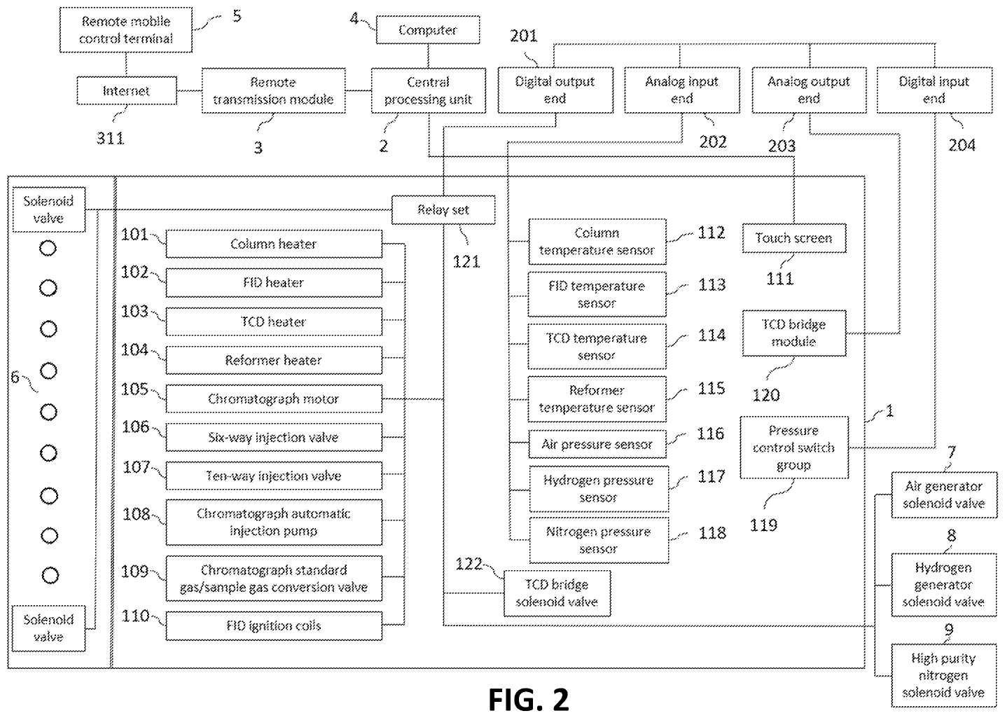

FIG. 2 illustrates a control method for the intelligent automatic control system for mine gas chromatographs, according to some examples. This method may include interfacing (such as clicking a button or touching a capacitance touch sensor) on the remote mobile control terminal 5 to turn on the power and a gas generator solenoid valve, such as the air generator solenoid valve 7, the hydrogen generator solenoid valve 8, and the high-purity nitrogen generator solenoid valve 9. In some examples, interfacing with the remote mobile control terminal 5 will turn on all three gas generator solenoid valves.

According to some examples, when the outlet pressures of the gas generator solenoid valves reach a pressure rating of the pressure-controlling switch group 119, the pressure-controlling switch group 119 will automatically begin to run. Upon the pressure-controlling switch group 119 beginning to run, the temperatures of the column temperature sensor 112, the FID temperature sensor 113, the TCD temperature sensor 114, and the reformer temperature sensor 115 will be checked. All temperature sensor values must be within a nominal range for the mine gas chromatograph 1 to start.

According to some examples, the column temperature sensor 112, which we will call T₁, must read between 0 degrees and 100 degrees Celsius. In some examples, the FID temperature sensor 113, which we will call T₂, must read between 0 degrees and 200 degrees Celsius. According to some examples, the TCD temperature sensor 114, which we will call T₃, must read between 0 degrees and 200 degrees Celsius. The reformer temperature sensor 115, which we will call T₄, must read between 0 degrees and 400 degrees Celsius. In other words, when 100° C.≥T₁>0° C., 200° C.≥T₂>0° C., 200° C.≥T₃>0° C., and 400° C.≥T₄>0° C., the mine gas chromatograph 1, as indicated on the remote mobile control terminal 5, may start normally. In other examples, these values may differ.

A next step in the control method may involve controlling the column heater 101, the FID heater 102, the TCD heater 103, and the reformer heater 104 through interfacing with the remote mobile control terminal 5 to heat the mine gas chromatograph 1. When the column temperature sensor 112 reads between 50 degrees and 80 degrees Celsius, the FID temperature sensor 113 reads between 80 degrees and 160 degrees Celsius, the TCD temperature sensor 114 reads between 80 degrees and 200 degrees Celsius, and the reformer temperature sensor 115 reads between 360 degrees and 400 degrees Celsius, or, when 80° C.≥T₁>50° C., 160° C.≥T₂>80° C., 200° C.≥T₃>80° C., and 400° C.≥T₄>360° C., the remote mobile control terminal 5 may indicate that the mine gas chromatograph 1 has achieved a normal and constant temperature. In other examples, these values may differ.

According to some examples, the various present pressure sensors are read after the temperature sensors achieve the desired normal and constant temperatures. In some examples, the air pressure sensor 116, which we will call P₁, must read between 0 and 1 Mega Pascals. According to some examples, the hydrogen pressure sensor 117, which we will call P₂, must also read between 0 and 1 Mega Pascals. In some examples, the nitrogen pressure sensor 118, which we will call P₃, must also read between 0 and 1 Mega Pascals. In other words, when 1 Mpa≥P₁>0 Mpa, 1 Mpa≥P₂>0 Mpa, and 1 Mpa≥P₃>0 Mpa, the mine gas chromatograph 1, as indicated on the remote mobile control terminal 5, may be determined to have a normal pressure. In other examples, these values may differ.

A next step may be to interface with the remote mobile control terminal 5 to turn on the TCD bridge solenoid valve 122. According to some examples, the TCD bridge solenoid valve 122 is turned on while ensuring that the TCD bridge module 120 has a current input of between 80 and 120 milliamps. In some examples, after the TCD bridge solenoid valve 122 has been turned on, the next step is to interface with the remote mobile control terminal 5 to connect the FID ignition coils 110, which will automatically ignite the FID.

According to some examples, the next step includes controlling the chromatograph standard gas/sample gas switch valve 109 through interfacing with the remote mobile control terminal 5. This may be done by interfacing with a control on the remote mobile control terminal 5 called “connect standard gas,” then “start analysis.” In some examples, the six-way injection valve 106 and the ten-way injection valve 107 will automatically exchange. According to some examples, the mine gas chromatograph 1 will then analyze and calibrate the standard gas.

In some examples, the next step is to set the number, a number of cycles, and analysis time and sampling time for the sample gas on the automatic control device of the external gas circuit 6 through interfacing with the remote mobile control terminal 5. According to some examples, the next step is to interface with the remote mobile control terminal 5 by clicking on “start analysis,” which will start the chromatograph automatic injection pump 108. The six-way injection valve 106 and the ten-way injection valve 107 may exchange automatically. In some examples, the mine gas chromatograph 1 will then analyze the sample gas.

According to some examples, upon the completion of gas analysis, the next step is to interface with the remote mobile control terminal 5 to turn off the column heater 101, the FID heater 102, the TCD heater 103, and the reformer heater 104. When the column temperature sensor 112 reads below 50 degrees Celsius, the FID temperature sensor 113 reads below 60 degrees Celsius, the TCD temperature sensor 114 reads below 60 degrees Celsius, and the reformer temperature sensor 115 reads below 100 degrees Celsius, or, when 50° C.≥T₁, 60° C.≥T₂, 60° C.≥T₃ and 100° C.≥T₄, the control relay units 121 of the column heater 101, the FID heater 102, the TCD heater 103, the reformer heater 104, the chromatograph motor 105, the air generator solenoid valve 7, the hydrogen generator solenoid valve 8, and the high-purity nitrogen generator solenoid valve 9 will shut off automatically. In some examples, the entire system will then shut down.

In some examples, when, upon turning on the system, the column temperature sensor 112 reads a value outside of the range of 0 degrees to 100 degrees Celsius, the FID temperature sensor 113 reads a value outside of the range of 0 degrees to 200 degrees Celsius, the TCD temperature sensor 114 reads a value outside of the range of 0 degrees to 200 degrees Celsius, or the reformer temperature sensor 115 reads a value outside of the range of 0 degrees to 400 degrees Celsius, or, when 100° C.≥T₁>0° C., 200° C.≥T₂>0° C., 200° C.≥T₃>0° C. or 400° C.≥T₄>0° C. is false, an alarm will sound. According to some examples, the system will shut down one minute after the alarm sounds. After maintenance is performed, the steps as detailed above may be repeated.

According to some examples, when, after the system has heated, the column temperature sensor 112 reads a value outside of the range of 50 degrees to 80 degrees Celsius, the FID temperature sensor 113 reads a value outside of the range of 80 degrees to 160 degrees Celsius, the TCD temperature sensor 114 reads a value outside of the range of 80 degrees to 200 degrees Celsius, or the reformer temperature sensor reads a value outside of the range of 360 degrees to 400 degrees Celsius, or, when 80° C.≥T₁>50° C., 160° C.≥T₂>80° C., 200° C.≥T₃>80° C. or 400° C.≥T₄>360° C. is false, an alarm will sound. In some examples, the system will shut down one minute after the alarm sounds. After maintenance is performed, the steps as detailed above may be repeated.

In some examples, when, after the system is turned on, the air pressure sensor 116 reads a value outside of the range of 0 to 1 Mega Pascals, the hydrogen pressure sensor 117 reads a value outside of the range of 0 to 1 Mega Pascals, or the nitrogen pressure sensor 118 reads a value outside of the range of 0 to 1 Mega Pascals, or, when 1 Mpa≥P₁>0 Mpa, 1 Mpa≥P₂>0 Mpa, and 1 Mpa≥P₃>0 Mpa is false, an alarm will sound. According to some examples, the system will shut down one minute after the alarm sounds. After maintenance is performed, the steps as detailed above may be repeated.

The control method for the above steps for an intelligent automatic control system for mine gas chromatography may be actuated by the computer programming embedded within the system. Additionally, according to some examples, the operation occurring on the remote mobile control terminal 5 may be actuated through a computer 4 or a touch screen 111.

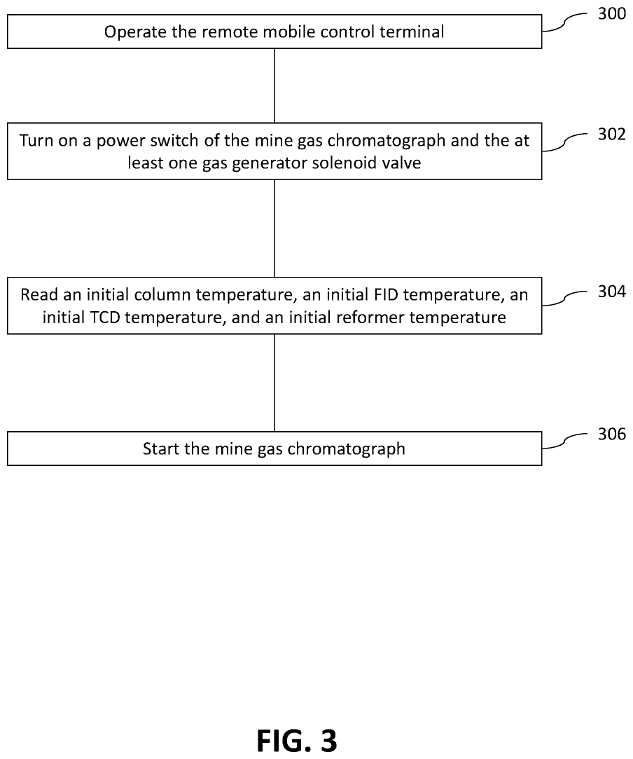

FIG. 3 illustrates a method of starting a mine gas chromatograph, wherein the intelligent automatic control system comprises a gas chromatograph, a remote mobile control terminal, at least one gas generator solenoid valve, a column, an FID, a TCD, and a reformer. In some examples, the method includes operating the remote mobile control terminal (at step 300). According to some examples, the method includes turning on, via operating the remote mobile control terminal, a power switch of the mine gas chromatograph and the at least one gas generator solenoid valve (at step 302). The method may include reading an initial column temperature, an initial FID temperature, an initial TCD temperature, and an initial reformer temperature (at step 304). In some examples, the method includes starting the mine gas chromatograph (at step 306).

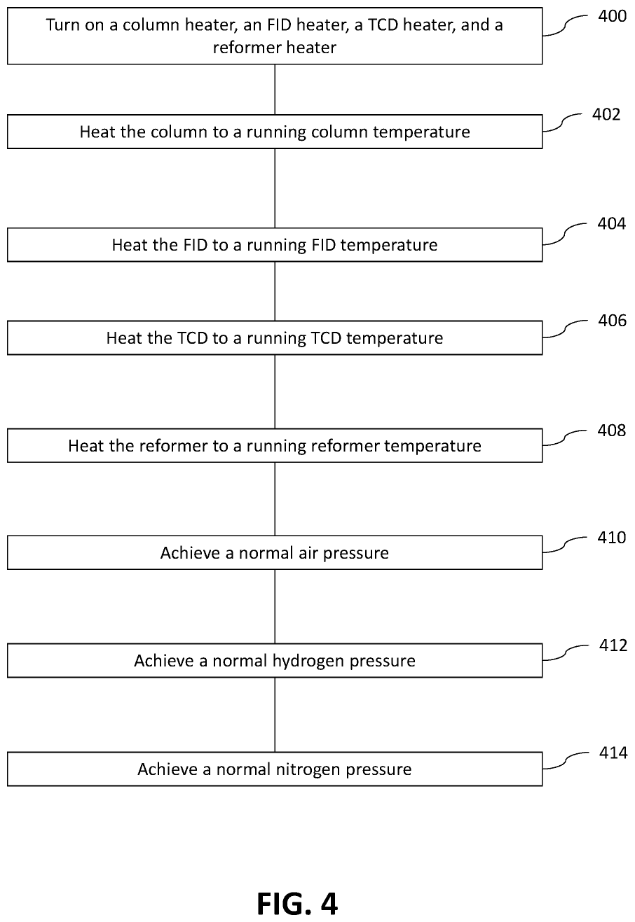

FIG. 4 illustrates a method of heating a mine gas chromatograph, according to some examples. According to some examples, the method includes turning on, via the remote mobile control terminal, a column heater, an FID heater, a TCD heater, and a reformer heater (at step 400). The method may include heating, via the column heater, the column to a running column temperature (at step 402). In some examples, the method includes heating, via the FID heater, the FID to a running FID temperature (at step 404). According to some examples, the method includes heating, via the TCD heater, the TCD to a running TCD temperature (at step 406). The method may include heating, via the reformer heater, the reformer to a running reformer temperature (at step 408). In some examples, the method includes achieving a normal air pressure, as read by an air pressure sensor (at step 410). According to some examples, the method includes achieving a normal hydrogen pressure, as read by a hydrogen pressure sensor (at step 412). The method may include achieving a normal nitrogen pressure, as read by a nitrogen pressure sensor (at step 414).

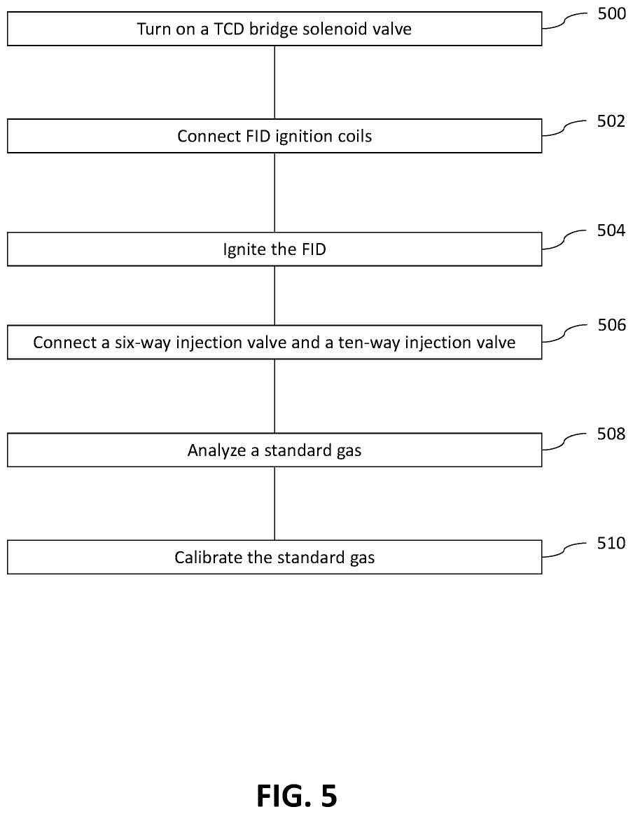

FIG. 5 illustrates a method of calibrating a mine gas chromatograph, according to some examples. In some examples, the method includes turning on, via the remote mobile control terminal, a TCD bridge solenoid valve (at step 500). According to some examples, the method includes connecting, via the remote mobile control terminal, FID ignition coils (at step 502). The method may include igniting, via connecting the FID ignition coils, the FID (at step 504). In some examples, the method includes connecting, via the remote mobile control terminal, a six-way injection valve and a ten-way injection valve (at step 506). According to some examples, the method includes analyzing, via the mine gas chromatograph, a standard gas (at step 508). The method may include calibrating, via the mine gas chromatograph, the standard gas (at step 510).

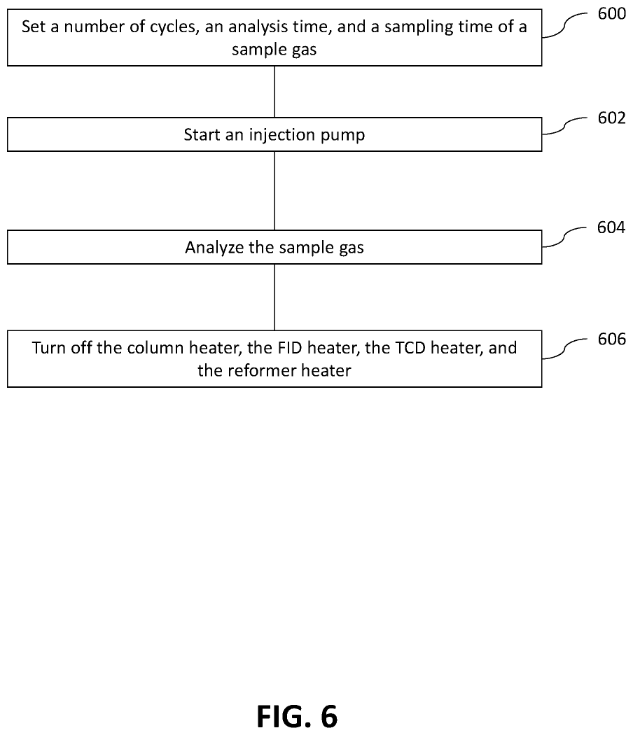

FIG. 6 illustrates a method of analyzing a sample gas and then turning off a mine gas chromatograph, according to some examples. In some examples, the method includes setting, via the remote mobile control terminal, a number of cycles, an analysis time, and a sampling time of a sample gas (at step 600). According to some examples, the method includes starting, via the remote mobile control terminal, an injection pump (at step 602). The method may include analyzing, via the mine gas chromatograph, the sample gas (at step 604). In some examples, the method includes turning off, via the remote mobile control terminal, the column heater, the FID heater, the TCD heater, and the reformer heater (at step 606).

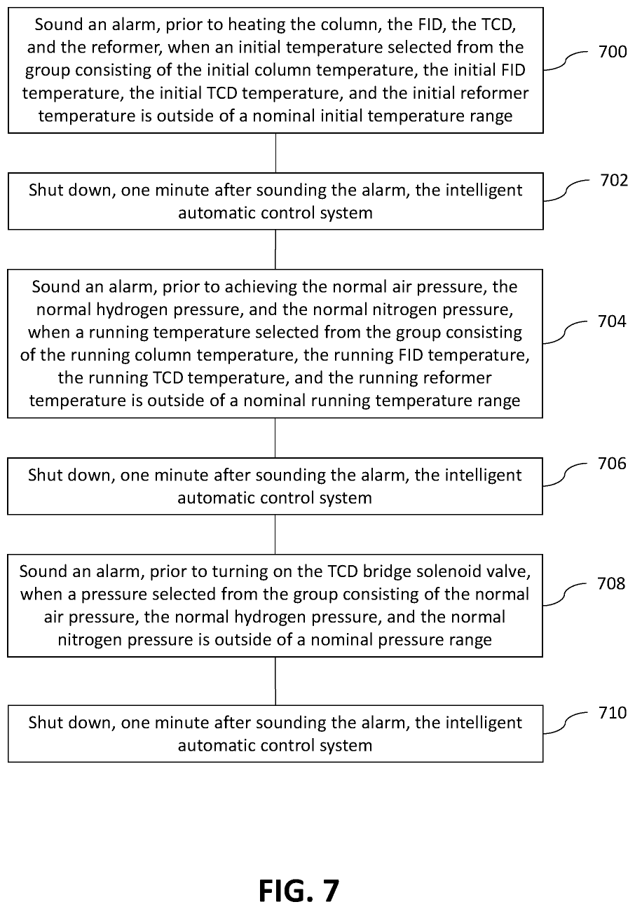

FIG. 7 illustrates a method of alarming and shutting down the system upon various nominal values, according to some examples. According to some examples, the method includes sounding an alarm, prior to heating the column, the FID, the TCD, and the reformer, when an initial temperature selected from the group consisting of the initial column temperature, the initial FID temperature, the initial TCD temperature, and the initial reformer temperature is outside of a nominal initial temperature range (at step 700). The method may include shutting down, one minute after sounding the alarm, the intelligent automatic control system (at step 702). In some examples, the method includes sounding an alarm, prior to achieving the normal air pressure, the normal hydrogen pressure, and the normal nitrogen pressure, when a running temperature selected from the group consisting of the running column temperature, the running FID temperature, the running TCD temperature, and the running reformer temperature is outside of a nominal running temperature range (at step 704). According to some examples, the method includes shutting down, one minute after sounding the alarm, the intelligent automatic control system (at step 706). The method may include sounding an alarm, prior to turning on the TCD bridge solenoid valve, when a pressure selected from the group consisting of the normal air pressure, the normal hydrogen pressure, and the normal nitrogen pressure is outside of a nominal pressure range (at step 708). In some examples, the method includes shutting down, one minute after sounding the alarm, the intelligent automatic control system (at step 710).

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

We claim:

1. A control method for an intelligent automatic control system for mine gas chromatographs, wherein the intelligent automatic control system comprises a mine gas chromatograph, a remote mobile control terminal, at least one gas generator solenoid valve, a column, an FID, a TCD, and a reformer, the method comprising:
operating the remote mobile control terminal;
turning on, via operating the remote mobile control terminal, a power switch of the mine gas chromatograph and the at least one gas generator solenoid valve;
reading an initial column temperature, an initial FID temperature, an initial TCD temperature, and an initial reformer temperature; and
starting the mine gas chromatograph.

2. The control method for an intelligent automatic control system for mine gas chromatographs of claim 1, further comprising turning on, via the remote mobile control terminal, a column heater, an FID heater, a TCD heater, and a reformer heater.

3. The control method for an intelligent automatic control system for mine gas chromatographs of claim 2, further comprising:
heating, via the column heater, the column to a running column temperature;
heating, via the FID heater, the FID to a running FID temperature;
heating, via the TCD heater, the TCD to a running TCD temperature; and
heating, via the reformer heater, the reformer to a running reformer temperature.

4. The control method for an intelligent automatic control system for mine gas chromatographs of claim 3, further comprising:
achieving a normal air pressure, as read by an air pressure sensor;
achieving a normal hydrogen pressure, as read by a hydrogen pressure sensor; and
achieving a normal nitrogen pressure, as read by a nitrogen pressure sensor.

5. The control method for an intelligent automatic control system for mine gas chromatographs of claim 4, further comprising turning on, via the remote mobile control terminal, a TCD bridge solenoid valve.

6. The control method for an intelligent automatic control system for mine gas chromatographs of claim 5, further comprising:
connecting, via the remote mobile control terminal, FID ignition coils; and
igniting, via connecting the FID ignition coils, the FID.

7. The control method for an intelligent automatic control system for mine gas chromatographs of claim 6, further comprising connecting, via the remote mobile control terminal, a six-way injection valve and a ten-way injection valve.

8. The control method for an intelligent automatic control system for mine gas chromatographs of claim 7, further comprising:
analyzing, via the mine gas chromatograph, a standard gas; and
calibrating, via the mine gas chromatograph, the standard gas.

9. The control method for an intelligent automatic control system for mine gas chromatographs of claim 8, further comprising setting, via the remote mobile control terminal, a number of cycles, an analysis time, and a sampling time of a sample gas.

10. The control method for an intelligent automatic control system for mine gas chromatographs of claim 9, further comprising:
starting, via the remote mobile control terminal, an injection pump; and
analyzing, via the mine gas chromatograph, the sample gas.

11. The control method for an intelligent automatic control system for mine gas chromatographs of claim 10, further comprising turning off, via the remote mobile control terminal, the column heater, the FID heater, the TCD heater, and the reformer heater.

12. The control method for an intelligent automatic control system for mine gas chromatographs of claim 3, further comprising sounding an alarm, prior to heating the column, the FID, the TCD, and the reformer, when an initial temperature selected from the group consisting of the initial column temperature, the initial FID temperature, the initial TCD temperature, and the initial reformer temperature is outside of a nominal initial temperature range.

13. The control method for an intelligent automatic control system for mine gas chromatographs of claim 12, further comprising shutting down, one minute after sounding the alarm, the intelligent automatic control system.

14. The control method for an intelligent automatic control system for mine gas chromatographs of claim 4, further comprising sounding an alarm, prior to achieving the normal air pressure, the normal hydrogen pressure, and the normal nitrogen pressure, when a running temperature selected from the group consisting of the running column temperature, the running FID temperature, the running TCD temperature, and the running reformer temperature is outside of a nominal running temperature range.

15. The control method for an intelligent automatic control system for mine gas chromatographs of claim 14, further comprising shutting down, one minute after sounding the alarm, the intelligent automatic control system.

16. The control method for an intelligent automatic control system for mine gas chromatographs of claim 5, further comprising sounding an alarm, prior to turning on the TCD bridge solenoid valve, when a pressure selected from the group consisting of the normal air pressure, the normal hydrogen pressure, and the normal nitrogen pressure is outside of a nominal pressure range.

17. The control method for an intelligent automatic control system for mine gas chromatographs of claim 16, further comprising shutting down, one minute after sounding the alarm, the intelligent automatic control system.

18. The control method for an intelligent automatic control system for mine gas chromatographs of claim 1, wherein operating the remote mobile control terminal comprises operating a device selected from the group consisting of a computer, a touch screen, a mobile phone, and combinations thereof.

19. An intelligent automatic control system for mine gas chromatographs, comprising:
a mine gas chromatograph;
a remote mobile control terminal communicatively coupled to the mine gas chromatograph;
at least one gas generator solenoid valve communicatively coupled to the remote mobile control terminal;
a column communicatively coupled to the remote mobile control terminal;
an FID communicatively coupled to the remote mobile control terminal;
a TCD communicatively coupled to the remote mobile control terminal;
a reformer communicatively coupled to the remote mobile control terminal; and
a non-transitory computer-readable media executable by a processor of remote mobile control terminal, the non-transitory computer-readable media configured to cause the remote control terminal to perform the steps of:
turning on a power switch of the mine gas chromatograph and the at least one gas generator solenoid valve;
reading an initial column temperature, an initial FID temperature, an initial TCD temperature, and an initial reformer temperature; and
starting the mine gas chromatograph.

20. The control method for an intelligent automatic control system for mine gas chromatographs of claim 1, the non-transitory computer-readable media configured to cause the remote control terminal to further perform the steps of:
turning on, via the remote mobile control terminal, a column heater, an FID heater, a TCD heater, and a reformer heater;
heating the column to a running column temperature;
heating the FID to a running FID temperature;
heating the TCD to a running TCD temperature; and
heating the reformer to a running reformer temperature.
